(19) United States
(12) Patent Application Publication
(10) Pub. No.: US 2003/0062984 A1
(43) Pub. Date: Apr. 3, 2003

(54) Thin film thermistor and method of adjusting reisistance of the same

(75) Inventors: Kenji Ito, Tokyo (JP); Yasutaka Tanaka, Tokyo (JP); Tadashi Toyoda, Tokyo (JP); Shouichi Tamura, Tokyo (JP)

Correspondence Address: McDERMOTT, WILL & EMERY, 600 13th Street, N.W., Washington, DC, 20005-3096, US

(73) Assignee: Ishizuka Electronics Corporation

(21) Appl. No.: 10/254,770

(22) Filed: Sep. 26, 2002

(30) Foreign Application Priority Data
Sep. 28, 2001 (JP) 2001-301196

(51) Int. Cl. H01C 3/04; H01C 7/02

(52) U.S. Cl. 338/25

(57) ABSTRACT

In a thin film thermistor with a cutting portion of a metallic pattern for resistance adjustment, initially, the resistance is roughly adjusted by adjusting the film thickness of a second heat-sensitive film, and secondly finely adjusted by trimming the cutting portion by laser irradiation. Thus, the thin film thermistor with a resistance adjusted accurately can be produced.

### BACKGROUND OF THE INVENTION

1. Field of the Invention

This invention relates to a structure of the thin film thermistor used for e.g. a temperature compensating circuit and temperature detecting element.

2. Description of the Related Art

In a conventional temperature-sensitive resistor incorporating a thin-film thermistor, in order to improve the accuracy of a resistance, the temperature-sensitive film was directly subjected to laser trimming. For example, JP-A-5-347205 discloses a method of adjusting the resistance of the resistor including a resistive thin film such as a temperature-sensitive resistor incorporating a resistive pattern for resistance adjustment and an insulating protective film with high permeability to a laser beam, which are formed on an insulating substrate. In this method, in order to adjust the resistance, the insulating protective film is irradiated with laser to trim the resistor pattern.

In this method, since the resistive pattern made of the resistive thin film is subjected directly to laser trimming, the resistive thin film generates heat to be evaporated owing to heat due to laser irradiation. Thus, the resistive thin film in the vicinity of the laser-irradiated region reacts with the protective film such as glass and hence its electric performance will be partially varied.

In the conventional method, since the resistive film is formed directly on the insulating substrate, in a heat treatment process for the resistive film and the protective film, a part of the component constituting the resistive film is diffused into the insulating substrate so that the composition of the resistive film, i.e. would be varied.

In order to solve such a problem, JP-A-2001-35705 proposes a thin film thermistor including a heat-sensitive film formed on an insulating substrate, and a pair of extraction electrodes and comb-like electrodes which alternately extend out toward the pair of extraction electrodes, in which a trimming electrode extending from the extraction electrode is formed on an insulating film formed at a portion of the heat-sensitive film. The method of adjusting the resistance proposed herein is to cut a part of the metallic pattern of the trimming electrode by laser irradiation.

In this case, in the trimming technique by laser irradiation, the heat-sensitive film is not directly trimmed, but the metallic pattern formed through the insulating film on the heat-sensitive film is trimmed so that the heat by laser irradiation is also transmitted to the heat-sensitive film through the insulating film. Owing to this, the electric characteristic of the heat-sensitive film having a large temperature coefficient like a thin film thermistor will be changed in trimming and hence the resistance cannot be adjusted accurately.

In the structure having the metallic pattern directly formed on the insulating film, the heat due to laser irradiation will be absorbed by the insulating substrate having large heat capacity during the trimming. Therefore, the laser output must be increased, otherwise the time for trimming must be lengthened. In this way, owing to the heat by laser irradiation, the resistance of the heat-sensitive film would be changed or its characteristic would be deteriorated.

In the heat treatment process, since a part of the component constituting the heat-sensitive film is diffused into the insulating substrate, the characteristic of the heat-sensitive film will be changed. As a result, the dispersion in the resistance becomes great. Thus, it was difficult to produce a product with a small tolerance by the laser trimming. In addition, reduction of contact strength between the heat sensitive film and the insulating substrate makes the electric characteristic of the heat-sensitive film unstable.

### SUMMARY OF THE INVENTION

An object of this invention is to provide a thermistor with small deterioration in the characteristic and a small change in the resistance of a heat-sensitive film having a structure in which a metallic pattern but not a resistive pattern is used as an area for adjusting the resistance through laser trimming and arranged on an insulating coating not so as to overlap with the heat-sensitive film.

In order to attain the above object, in accordance with one aspect of this invention, there is provided a thin film thermistor comprising:

an insulating substrate;

an insulating coating formed on a principal surface of the insulating substrate;

a pair of comb-like electrodes formed oppositely to each other on the insulating coating;

a pair of extraction electrodes connected to the pair of comb-like electrodes,

a metallic pattern for resistance adjustment extended from at least one of the pair of extraction electrodes, the metallic pattern having a cutting area for trimming;

a heat-sensitive film formed to overlie the pair of comb-like electrodes and a part of the cutting portion for trimming; and

a protection film overlying the heat-sensitive film.

Further, there is provided a thin film thermistor comprising:

an insulating substrate;

an insulating coating formed on a principal surface of the insulating substrate;

a pair of comb-like electrodes formed oppositely to each other on the insulating coating;

a pair of extraction electrodes connected to the pair of comb-like electrodes,

a metallic pattern for resistance adjustment extended from at least one of the pair of extraction electrodes, the metallic pattern having a cutting area for trimming;

a first heat-sensitive film formed to overlie the pair of comb-like electrodes and a part of the cutting portion for trimming;

a second heat-sensitive film stacked on the first heat-sensitive film; and

a protection film overlying the first and second heat-sensitive films.

Further, there is provided a thin film thermistor comprising:

an insulating substrate;

an insulating coating formed on a principal surface of the insulating substrate;

a first heat-sensitive film formed on the insulating coating;

a pair of comb-like electrodes formed oppositely to each other on the insulating coating;

a pair of extraction electrodes connected to the pair of comb-like electrodes,

a metallic pattern for resistance adjustment extended from at least one of the pair of extraction electrodes, the metallic pattern having a cutting area for trimming;

a second heat-sensitive film formed to overlie a part of the pair of comb-like electrodes and the cutting portion for trimming; and

a protection film overlying the first and second heat-sensitive films.

In the above thin film thermistors, preferably, the thin film thermistor comprises a pair of underlying electrodes formed on the insulating substrate, between which the heat-sensitive film or the first and second heat-sensitive films are formed on the insulating coating.

In the thin film thermistor as just above, preferably, the pair of extraction electrodes are formed on the insulating substrate through the underlying electrodes.

In the thin film thermistors as described above, preferably, the insulating coating is made of SiO₂, Si₃N₄ or zirconia.

In the thin film thermistors as described above, the protection film is made of lead borosilicate glass or insulating heat-resistant resin.

In accordance with another aspect of this invention, there is provided a method of adjusting a resistance of the thin film thermistor, comprising the steps of:

computing a film thickness of the second heat-sensitive film to be formed on the basis of the resistance measured after the first heat-sensitive film has been formed;

forming the second heat-sensitive film having the film thickness thus computed, thereby roughly adjusting the resistance;

determining an area to be trimmed of the cutting portion from the resistance after the protection film has been formed on the basis of trimming data previously acquired by simulation and

trimming the area thus determined by laser irradiation from above the protection film thereby finely adjusting the resistance into a desired value.

Further, there is provided a method of adjusting a resistance of the thin film thermistor, comprising the steps of:

computing a film thickness of the second heat-sensitive film to be formed on the basis of the resistance measured after the pair of comb-like electrodes and the metallic pattern have been formed;

forming the second heat-sensitive film having the film thickness thus computed, thereby roughly adjusting the resistance;

determining an area to be trimmed of the cutting portion from the resistance after the protection film has been formed on the basis of trimming data previously acquired by simulation and

trimming the area thus determined by laser irradiation from above the protection film, thereby finely adjusting the resistance into a desired value.

In accordance with this invention, since a thermally stable insulating coating selectively formed on the insulating substrate serves as a barrier, a component constituting the heat-sensitive film is not diffused into an insulating substrate, thereby preventing the composition of the heat-sensitive film from being changed and hence a thin film thermistor with stable characteristic with small dispersion thereof can be provided.

Owing to provision of the insulating film, the heat by laser irradiation is not absorbed by the insulating substrate having large heat capacity so that the heat can be accurately transmitted to the area for trimming. This enables the trimming to be done within a short time, thereby providing a structure in which the characteristic of the heat sensitive film is difficult to deteriorate or change during trimming. Thus, the resistance of the thin film thermistor can be adjusted more precisely.

In the thin film thermistor according to this invention, unlike the prior art, the resistive film is not directly trimmed, but the metallic pattern for resistance adjustment is provided separately from the heat-sensitive film(s), and the cutting portions thereof for trimming are formed at a position apart from the heat-sensitive films and cut by laser to adjust the resistance. For this reason, the heat-sensitive films are not directly irradiated with the laser light. Therefore, no change in the resistance of the heat-sensitive film or deterioration in its characteristic will occur owing to the heat by laser irradiation, thus providing the thin film thermistor with improved reliability.

Since the insulating coating which is thermally stable is selectively formed on the insulating substrate and the heat-sensitive film is arranged on the insulating coating, it does not almost occur that a part of the component of the heat-sensitive film is thermally diffused into the insulating substrate and the electrical characteristic of the heat-sensitive film varies. Therefore, a change in the resistance which is attributable to this cause is small and hence the resistance can be easily adjusted by trimming, thereby increasing the production yield of the products of the thin film thermistor. Further, since the heat-sensitive film is sealed between the insulating coating and the protection film, the thin film thermistor is stable to the environment. This increases the reliability of the thermistor according to this invention.

Further, since the metallic pattern for resistance adjustment is arranged on the insulating coating, the heat due to laser irradiation is difficult to be absorbed in the insulating substrate having a large thermal capacity. For this reason, during trimming, the output energy of the laser can be suppressed so that even when the trimming time is shortened, the thermal energy can be transmitted to the portion to be trimmed. Thus, the trimming can be can be executed in a shorter time than in the prior art. As a result, the influence of the heat due to laser irradiation on the heat-sensitive film is suppressed so that deterioration of the heat-sensitive film and a change in the resistance disappear, thereby improving the reliability of the thin film thermistor.

The second heat-sensitive film for rough adjustment of the resistance is formed on the first heat-sensitive film. In this case, initially, the resistance is roughly adjusted by adjusting the film thickness of the second heat-sensitive film, and next, it is finely adjusted by trimming the cutting area for trimming of the metallic pattern for resistance adjustment, thereby providing a thin film thermistor having a small tolerance from a target resistance. On the basis of the experimental result executed, the thin film thermistors having a tolerance of ±1% could be manufactured with a production yield of 95%.

In manufacturing the thin film thermistors according to this invention, before a large number of the thin film thermistors formed on a single insulating substrate are divided into individual chips, their resistances are successively measured. Further, the position and resistance of each thin film thermistor are stored in a processing unit as an address data and a resistance data. On the basis of the trimming data which are previously acquired by simulation, the processing for determining the area to be trimmed from the measured resistance is executed. These steps are automatically executed by the processing unit. For this reason, each of the resistances of the thin film thermistor can be adjusted in a short time. Further, the resistance of the resistive film having a large temperature coefficient such as the thin film thermistor can be adjusted accurately without being affected by the heat due to laser irradiation. Thus, the thin film thermistors having a small tolerance can be manufactured with improved production yield.

The above and other objects and features of the invention will be more apparent from the following description taken in conjunction with the accompanying drawings.

### BRIEF DESCRIPTION OF THE DRAWINGS

FIG. 1 is a view for explaining the structure of a thermistor according to an embodiment of this invention;

FIGS. 2A and 2B are sectional views of the thin film thermistor taken in line B-B and line C-C, respectively;

FIGS. 3A to 3C are views for explaining the process for manufacturing the thin film thermistor shown in FIG. 1; and

FIG. 3D is a partially enlarged view of the metallic pattern for resistance adjustment shown in FIG. 1;

FIG. 4 is a view for explaining the structure of a thermistor according to another embodiment of this invention;

FIG. 5 is a sectional view of the thin film thermistor taken in line D-D in FIG. 4.

### DESCRIPTION OF THE PREFERRED EMBODIMENTS

Now referring to the drawings, an explanation will be given of various embodiment of the thin film thermistor according to this invention.

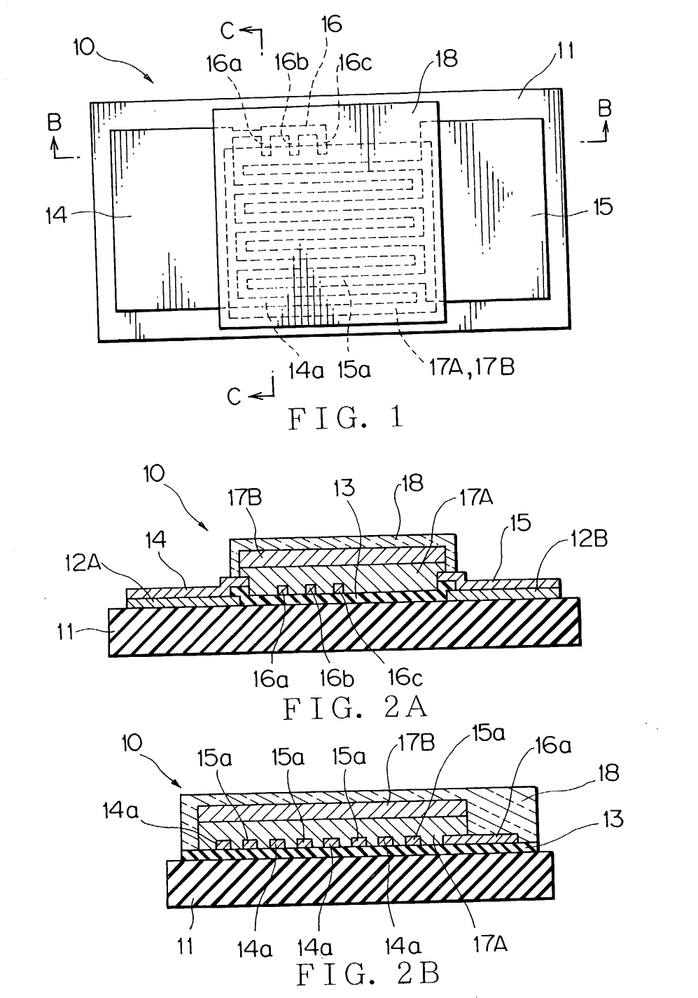

In FIGS. 1 and 2, reference numeral 10 denotes a thin film thermistor. The thin film thermistor 10 includes an insulating substrate 11, a pair of opposed underlying electrodes 12A and 12B which are formed on the insulating substrate 11, an insulating coating 13 formed between the underlying electrodes 12A and 12B, extraction electrodes 14 and 15, comb-like electrodes 14a and 15a which are extended form the extraction electrodes 14 and 15 onto the insulating coating 13, a metallic pattern 16 for resistance adjustment having cutting portions 16a, 16b and 16c for trimming which are electrically connected to the extraction electrode 14, a first heat-sensitive film 17A formed on the comb-like electrodes 14a and 15a, a second heat-sensitive film 17B formed on the first heat-sensitive film 17A, and a protective film 18.

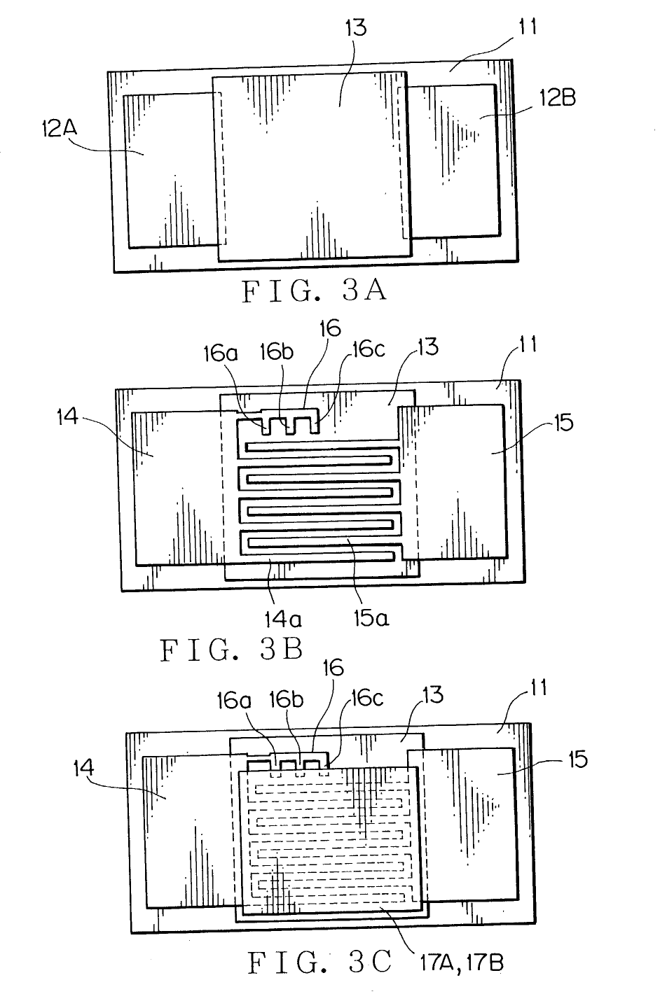

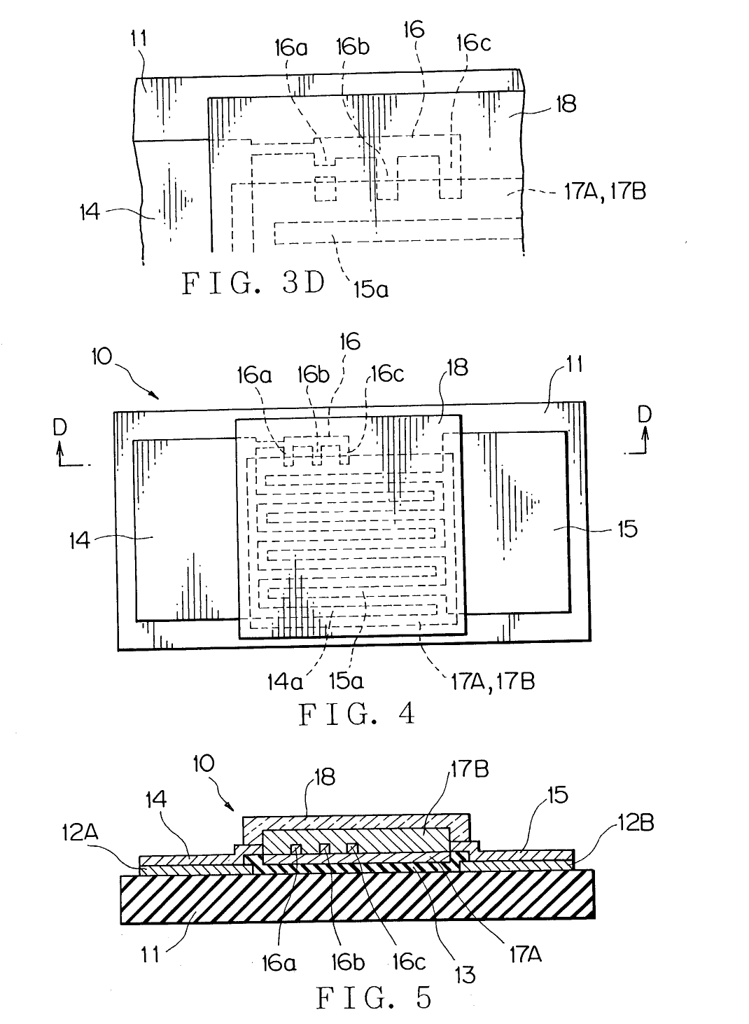

Referring to FIG. 3, an explanation will be given of a method of manufacturing the thin film thermistor 10 according to this invention.

First, on the principal surface of the insulating substrate 11 of ceramics such as alumina, quartz, mullite, steatite, etc., as shown in FIG. 3A, by e.g. sputtering, a first metallic film of titanium (Ti), molybdenum (Mo) or chrome (Cr) which constitutes an underlying electrode is deposited. Thereafter, on the first metallic film, by sputtering, a second metallic film of platinum (Pt), palladium (Pd) or tantalum (Ta) which also constitutes the underlying electrode is deposited.

Using the known photoetching, unnecessary portions are removed, underlying electrodes 12A and 12B are formed on the insulating substrate 11.

As seen from FIG. 3A and also FIG. 2A, the insulating coating 13 of SiO₂, Si₃N₄ or zirconia having a thickness of 0.1 μm-1.0 μm is patterned on the insulating substrate 11.

By sputtering, a metallic film of platinum (Pt), palladium (Pd) or tantalum (Ta) is deposited on the insulating substrate in order to the extraction electrode 14, 15, comb-like electrodes 14a, 15a and metallic pattern 16 for resistance adjustment.

By photoetching, the unnecessary areas are removed to form the comb-like electrodes 14a and 15a connected to the extraction electrodes 14 and 15 so that they are opposite to each other on the insulating coating 13, and to form the metallic pattern 16 for resistance adjustment having the cutting portions 16a, 16b and 16c for trimming connected to the extraction electrode 14 on the insulating coating 13.

By the known technique such as sputtering, using sintered body of composite oxide of manganese (Mn), cobalt (Co), nickel (Ni) or iron (Fe) as a target, a heat-sensitive film having a thickness of 0.1 μm-2.0 μm is deposited on the insulating coating 13.

As seen from FIG. 3C, an unnecessary portion of the deposited heat-sensitive film is removed by photoetching. The remaining portion thereof is heat-treated at a temperature of 500° C.-1000° C. so that its characteristic is stabilized, thereby forming the first heat-sensitive film 17A. The first heat-sensitive film 17A is patterned to be overlaid on the tips of the cutting portions 16a, 16b and 16c for trimming of the metallic pattern 16 for resistance adjustment.

At this stage, the resistance of the first heat-sensitive film 17A is measured. On the basis of the measured data, the film thickness of a second heat-sensitive film to be formed as described below is determined. The second heat-sensitive film 17B will be made as occasion demands.

Specifically, in order to form the second heat-sensitive film 17B on the first heat-sensitive film 17, first the resistance of the first heat-sensitive film 17A is measured. On the basis of the measured resistance of the first heat-sensitive film 17A, the film thickness of the second heat-sensitive film to be formed is computed to roughly adjust the resistance of the thermistor at a desired value. The time required for sputtering is computed on the basis of the computed film thickness of the second heat-sensitive film 17B. By sputtering during the computed time, the second heat-sensitive film 17B is formed on the first heat-sensitive film 17A using the same target as that for the first heat-sensitive film 17A. The second heat-sensitive film 17B is thereafter patterned in a prescribed pattern. After the patterning, the second heat-sensitive film 17B is heat-treated at a temperature of 500° C.-1000C.°.

Incidentally, if the measured resistance of the first heat-sensitive film 17A is in the vicinity of the desired resistance, it is not necessary to form the second heat-sensitive film 17B. The heat-sensitive films 17A and 17B may have slits among the cutting portions 16a, 16b and 16c for trimming which are extended from the metallic pattern 16 for resistance adjustment.

In the process described above, as seen from FIG. 3B, after the comb-like electrode 14a and the metallic pattern 16 have been patterned, the heat-sensitive films 17A and 17B are stacked. However, as seen from FIGS. 4 and 5, in another embodiment of this invention, first, the first heat-sensitive film is patterned and on the first heat-sensitive film thus patterned, the comb-like electrode 14a and the metallic pattern 16 for resistance adjustment are patterned. The second heat-sensitive film may be thereafter formed. In this case, the comb-like electrode 14a and the metallic pattern 16 for resistance adjustment are partially sandwiched between the first and second heat-sensitive films.

In order to form a protective film 18 for protecting the heat-sensitive films 17A and 17B, glass paste having lead borosilicate as a main component (or insulating heat-sensitive resin) is printed on the heat-sensitive films 17A and 17B by screen printing, thereby forming a lead borosilicate glass layer. The glass layer thus formed is baked to provide the protective film 18, thus completing the thin film thermistor 10. Incidentally, a series of the respective steps described above are executed by patterning to provide a large number of thin film thermistors formed on a single sheet of insulating substrate. Finally, the above protective film is formed. At this time, the large number of thin film thermistors have been placed on the single insulating substrate.

Before scribing, the resistance of each of the thin film thermistors formed on the insulating substrate 11 is finely adjusted. The fine adjustment of the resistance is carried out in such a manner that the suitable portion of the cutting portions 16a, 16b and 16c for trimming of the metallic pattern 16 for resistance adjustment is cut by laser irradiation.

First, the resistances of the large number of thin film thermistors 10 formed on the insulating substrate are successively measured. Further, the position and resistance of each thin film thermistor are stored in a processing unit (not shown) as an address data and a resistance data. On the basis of the trimming data which are previously acquired by simulation, the processing for determining the area to be trimmed from the measured resistance is executed. Thus, what portion of the cutting portions 16a, 16b and 16c should be cut is determined.

According to the prescribed condition, one or plurality of the cutting portions 16a, 16b and 16c are cut by irradiating the protective film 17 with the laser light with a wavelength of 900 nm-1400 nm, thereby acquiring the thin film thermistors each having a desired resistance.

FIG. 3D is an enlarged view of the cutting portions for trimming in which the cutting portion 16a is cut. The shape size and arrangement of the area to be cut should not be limited the example of FIG. 3D. Considering the range of the resistance to be finely adjusted and the resistivity of the heat-sensitive films, the contact area of the cutting portions with the heat-sensitive films, the shape thereof and the distance thereof from the opposite electrode (the comb-like electrode 15a in this embodiment) are determined. In this embodiment, the heat-sensitive films have been provided as two stacked layers. However, three or more heat-sensitive layers may be provided as a means for roughly adjusting the resistance of the thin film thermistor.

Finally, the large number of thin film thermistors formed on the insulating substrate are scribed and diced by a dicing means, thereby providing individual products of the thin film thermistors.

Incidentally, the contents of Japanese Patent Appln. No. 2001-301196 filed on Sep. 28, 2001 are hereby incorporated by reference.

What is claimed is:

1. A thin film thermistor comprising:
an insulating substrate;
an insulating coating formed on a principal surface of said insulating substrate;
a pair of comb-like electrodes formed oppositely to each other on the insulating coating;
a pair of extraction electrodes connected to said pair of comb-like electrodes,
a metallic pattern for resistance adjustment extended from at least one of said pair of extraction electrodes, said metallic pattern having a cutting area for trimming;
a heat-sensitive film formed to overlie said pair of comb-like electrodes and a part of said cutting portion for trimming; and
a protection film overlying said heat-sensitive film.

2. A thin film thermistor comprising:
an insulating substrate;
an insulating coating formed on a principal surface of said insulating substrate;
a pair of comb-like electrodes formed oppositely to each other on the insulating coating;
a pair of extraction electrodes connected to said pair of comb-like electrodes,
a metallic pattern for resistance adjustment extended from at least one of said pair of extraction electrodes, said metallic pattern having a cutting area for trimming;
a first heat-sensitive film formed to overlie said pair of comb-like electrodes and a part of said cutting portion for trimming;
a second heat-sensitive film stacked on said first heat-sensitive film; and
a protection film overlying said first and second heat-sensitive films.

3. A thin film thermistor comprising:
an insulating substrate;
an insulating coating formed on a principal surface of said insulating substrate;
a first heat-sensitive film formed on said insulating coating;
a pair of comb-like electrodes formed oppositely to each other on the first heat-sensitive film;
a pair of extraction electrodes connected to said pair of comb-like electrodes,
a metallic pattern for resistance adjustment extended from at least one of said pair of extraction electrodes, said metallic pattern having a cutting area for trimming;
a second heat-sensitive film formed to overlie a part of said pair of comb-like electrodes and said cutting portion for trimming; and
a protection film overlying said first and second heat-sensitive films.

4. A thin film thermistor according to any one of claims 1, 2 and 3 further comprising a pair of underlying electrodes formed on said insulating substrate, between which said heat-sensitive film or said first and second heat-sensitive films are formed on said insulating coating.

5. A thin film thermistor according to claim 4, wherein said pair of extraction electrodes are formed on the insulating substrate through said underlying electrodes.

6. A thin film thermistor according to any one of claims 1 to 3, wherein said insulating coating is made of SiO2, Si3N4 or zirconia.

7. A thin film thermistor according to any one of claims 1 to 3, wherein said protection film is made of lead borosilicate glass or insulating heat-resistant resin.

8. A method of adjusting a resistance of the thin film thermistor according to claim 2, comprising the steps of:
computing a film thickness of said second heat-sensitive film to be formed on the basis of the resistance measured after said first heat-sensitive film has been formed;
forming said second heat-sensitive film having the film thickness thus computed, thereby roughly adjusting the resistance;
determining an area to be trimmed of said cutting portion from the resistance after the protection film has been formed on the basis of trimming data previously acquired by simulation and
trimming said area thus determined by laser irradiation from above said protection film, thereby finely adjusting the resistance into a desired value.

9. A method of adjusting a resistance of the thin film thermistor according to claim 3, comprising the steps of:
computing a film thickness of said second heat-sensitive film to be formed on the basis of the resistance measured after said pair of comb-like electrodes and said metallic pattern have been formed;
forming said second heat-sensitive film having the film thickness thus computed, thereby roughly adjusting the resistance;
determining an area to be trimmed of said cutting portion from the resistance after the protection film has been formed on the basis of trimming data previously acquired by simulation and
trimming said area thus determined by laser irradiation from above said protection film, thereby finely adjusting the resistance into a desired value.
